(19) United States
(12) Patent Application Publication
(10) Pub. No.: US 2024/0311719 A1
(43) Pub. Date: Sep. 19, 2024

(54) COMPUTER OPTIMIZED DETERMINATION OF PRODUCT AVAILABILITY

(71) Applicant: International Business Machines Corporation, Armonk, NY (US)

(72) Inventors: Yihua LI, San Jose, CA (US); Xiaowei BAO, Portland, OR (US); Zuochun TANG, San Francisco, CA (US); Robert PARKIN, Foster City, CA (US)

(21) Appl. No.: 18/184,416

(22) Filed: Mar. 15, 2023

(51) Int. Cl. G06Q 10/0631; G06Q 10/067; G06Q 10/087; G06Q 30/0202

(52) U.S. Cl. CPC G06Q 10/06315; G06Q 10/067; G06Q 10/087; G06Q 30/0202

(57) ABSTRACT

Generation of an available to promise (ATP) value. A method identifies business constraints and goals for an omnichannel retailer based on input quantitative and qualitative data. The method determines numerical parameters for use in an executable optimization model and using a machine learning model. Additionally, the method builds the executable optimization model using at least one of the goals as a respective at least one objective in the optimization model, at least one of the constraints as a respective at least one constraint in the optimization model, and at least one of the numerical parameters as at least one additional parameter in the executable optimization model. In addition, the method executes the executable optimization model and generates an ATP value, and outputs the ATP value to an e-commerce system.

### BACKGROUND

Available-to-promise (ATP) is a concept referring to a quantity of product to present as being available to purchase by prospective buyers at a given point in time. Usually a determination of ATP is made in real-time and based on an actual inquiry by a system or user. The determination accounts for current inventory levels, customer orders, and expected upcoming supply/demand.

### SUMMARY

Shortcomings of the prior art are overcome and additional advantages are provided through the provision of a computer-implemented method. The method identifies, for an omnichannel retailer, and based on input quantitative data and input qualitative data, a collection of business constraints and a collection of business goals. The method also determines, using a machine learning model with the collection of business constraints and collection of business goals, numerical parameters for use in an executable optimization model. The method builds the executable optimization model using at least one goal of the collection of goals as a respective at least one objective in the optimization model, at least one constraint of the collection of constraints as a respective at least one constraint in the optimization model, and at least one of the determined numerical parameters as at least one additional parameter in the executable optimization model. The method additionally executes the executable optimization model and generates, based on the executing, an available-to-promise value. The available-to-promise value includes an indication of how much inventory of the retailer should be made available to promise to prospective online orders. Additionally, the method outputs the available-to-promise value to an e-commerce system for presentation to potential purchasers.

Further, a computer system is provided that includes a memory and a processor in communication with the memory, wherein the computer system is configured to perform a method. The method identifies, for an omnichannel retailer, and based on input quantitative data and input qualitative data, a collection of business constraints and a collection of business goals. The method also determines, using a machine learning model with the collection of business constraints and collection of business goals, numerical parameters for use in an executable optimization model. The method builds the executable optimization model using at least one goal of the collection of goals as a respective at least one objective in the optimization model, at least one constraint of the collection of constraints as a respective at least one constraint in the optimization model, and at least one of the determined numerical parameters as at least one additional parameter in the executable optimization model. The method additionally executes the executable optimization model and generates, based on the executing, an available-to-promise value. The available-to-promise value includes an indication of how much inventory of the retailer should be made available to promise to prospective online orders. Additionally, the method outputs the available-to-promise value to an e-commerce system for presentation to potential purchasers.

Yet further, a computer program product including a computer readable storage medium readable by a processing circuit and storing instructions for execution by the processing circuit is provided for performing a method. The method identifies, for an omnichannel retailer, and based on input quantitative data and input qualitative data, a collection of business constraints and a collection of business goals. The method also determines, using a machine learning model with the collection of business constraints and collection of business goals, numerical parameters for use in an executable optimization model. The method builds the executable optimization model using at least one goal of the collection of goals as a respective at least one objective in the optimization model, at least one constraint of the collection of constraints as a respective at least one constraint in the optimization model, and at least one of the determined numerical parameters as at least one additional parameter in the executable optimization model. The method additionally executes the executable optimization model and generates, based on the executing, an available-to-promise value. The available-to-promise value includes an indication of how much inventory of the retailer should be made available to promise to prospective online orders. Additionally, the method outputs the available-to-promise value to an e-commerce system for presentation to potential purchasers.

Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts an example workflow for identifying business goals and constraints, and determining parameters for use in an executable optimization model, in accordance with aspects described herein;

FIG. 3 depicts an example conceptual formulation of an executable optimization model, in accordance with aspects described herein;

FIG. 4 depicts further details of an example available to promise module to incorporate and/or use aspects described herein; and

FIG. 5 depicts an example process for available to promise determination, in accordance with aspects described herein.

### DETAILED DESCRIPTION

Described herein are approaches for optimized determination of available-to-promise levels for omnichannel retailers. Omnichannel retailers are now having to make decisions as to how much of their inventory they should reserve for future online sales (in comparison to sales in their other channels, for instance brick and mortar stores). Conventionally, this was done during the fulfillment stage after a customer had already made a purchase; the purchased item quantity was marked as “promised” and removed from a quantity of inventory available for future orders. However, modernized approaches to retail have changed consumer expectations. Consumers now demand that the retailer inform them before they make a purchase decision both how much inventory is available and when such inventory might be delivered. As noted, available-to-promise (ATP; sometimes written “available to promise”) is a projected amount of inventory that the retailer wants to show consumers, prior to purchase, is available, in stock, and ready to sell (not already allocated for existing customer orders), and often incorporates a timing aspect (e.g., delivery schedule by a given date).

There are implications to a retailer providing higher or lower ATP values. Too low an ATP value could dampen the retail responsiveness to customers order inquiries and business revenue. In other words, ff set too low, the online retailer might tend to lose sales since the online shopping platform (e.g., a website) will be more likely to show an items as low inventory or out of stock. Consumers might tend to not buy the item fearing that it is actually out of stock. In contrast, too high an ATP value may lead to operation failures and customer dissatisfaction. If set too high, then the online retailer can expect higher revenue because of the additional opportunities for customers to purchase the item, but the retailer risks running out of stock or not being able to fulfill order(s) on time (for instance, by the time the customer checks-our/pays, the item is no longer available). It is seen that there is a tradeoff in selecting an ATP value, the tradeoff being between lost sales (if using a lower ATP) and low customer satisfaction (is using a higher ATP). Compounding the above are additional issues. Orders might ship from multiple different locations each having different inventory statuses, consumers might cancel orders after they have already been promised, or orders might be rescheduled either by the consumer or the retailer for other reasons, as examples.

In general, it is desired to find the ‘best’ ATP values for a retailer, and ATP solutions may be highly sought-after by omnichannel retailers in order to reduce operation cost and increase customer satisfaction. Conventionally, many solutions for ATP determination are rules-based, and simply allocate a fixed percentage of inventory as being available to promise. A rules-based approach does not address the above issues and fails to find a best solution that is tailored to the particular business model and goals of the omnichannel retailer for with the ATP value is determined.

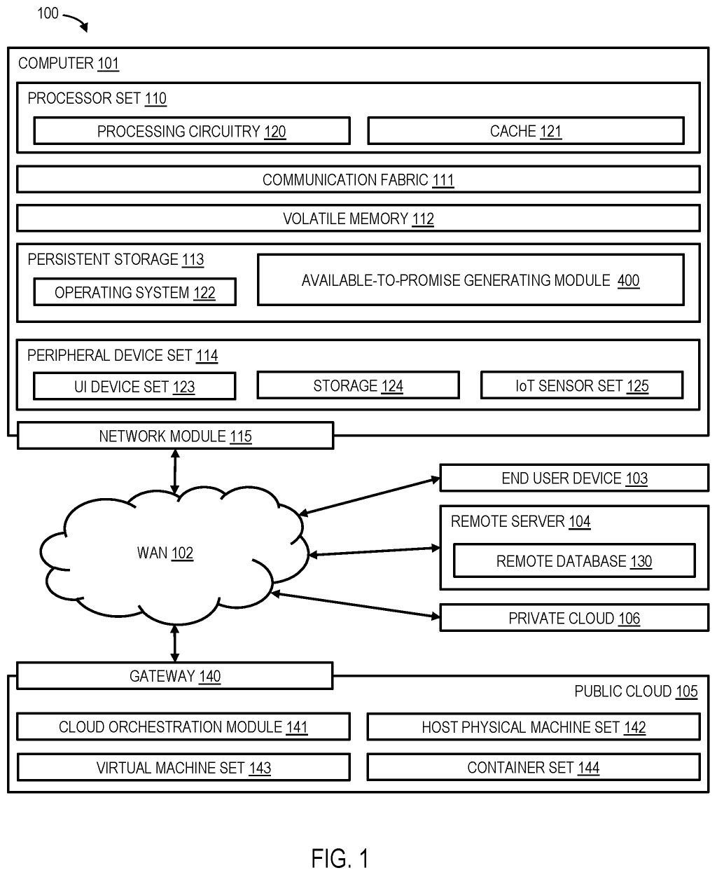

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code of available-to-promise generating module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above in FIG. 1 is only one example of a computing environment to incorporate, perform, and/or use aspect(s) of the present invention. Other examples are possible. For instance, in one or more embodiments, one or more of the components/modules of FIG. 1 are not included in the computing environment and/or are not used for one or more aspects of the present invention. Further, in one or more embodiments, additional and/or other components/modules may be used. Other variations are possible.

Aspects described herein use a combination of predictive modeling and optimization modeling to generate and inform how much inventory (ATP value) should be made available to promise to incoming online orders for an omnichannel retailer. In general, a process builds an optimization model to generate optimal ATP values for the omnichannel retailer, enabling the omnichannel retailer to optimize its choice of an available to promise level for items in the retailer's online store for purposes of order promise and fulfillment. Aspects find an optimal amount of product availability while accounting for the retailer's potentially unique business constraints and goals, enabling the retailer to define its own rules and provide an optimization according to those rules.

Specifically, a first aspect is to gain an understanding of the omnichannel retailer's unique business context by identifying business constraints and goals, and estimating numerical parameters. This aspect identifies the primary objectives and constraints that are to be fulfilled. Some retailers will focus primarily on revenue and profitability, while others may weigh more toward customer satisfaction. Additionally, there are constraints on the business-things like the locations from which shipments can originate, the carriers used, and timing of deliveries. Other constraints may be placed on target order cancellation rate, the level of cancellations the retailer is willing to accept, product or group level constraints on availability, and minimum/maximum units to expose, as examples.

This aspect also includes estimating required parameters for decision making—predicting future demand and inventory, future order cancellation rate (where customers have canceled orders that have been promised), and reschedule probability (where the retailer or customer changes the delivery timing), as examples. In some embodiments, this can be done with a machine learning model and/or with statistical techniques and based on historical data, as explained herein.

As second aspect derives, based on estimated parameters and the constraints and goals, an available-to-promise optimization model (ATPOP) by designing and implementing the optimization model based on what was learned in the first aspect. Then the ATPOP is solved to provide optimal ATP value(s). The solving involves running/executing that model and making recommendations. As an enhancement, the ATPOP could be generalized across different domains, for instance different types of commodity domains, as an example. This could entail generalizing the model and inputs so that they will work across different such domains. It may be desired to use different kinds of predictive models for relatively fast-moving inventory items in comparison to relative slow-moving inventory items, or to have different kinds of constraints/objectives for high-value items in comparison to commodity goods, as examples.

Accordingly, and as described further herein, aspects can leverage a combination of time-series models, regression models, and decision optimization techniques to provide optimized ATP determination for the omnichannel retailer. Such a combination of machine learning and optimization techniques can help solve the problem of optimal ATP determination/level selection.

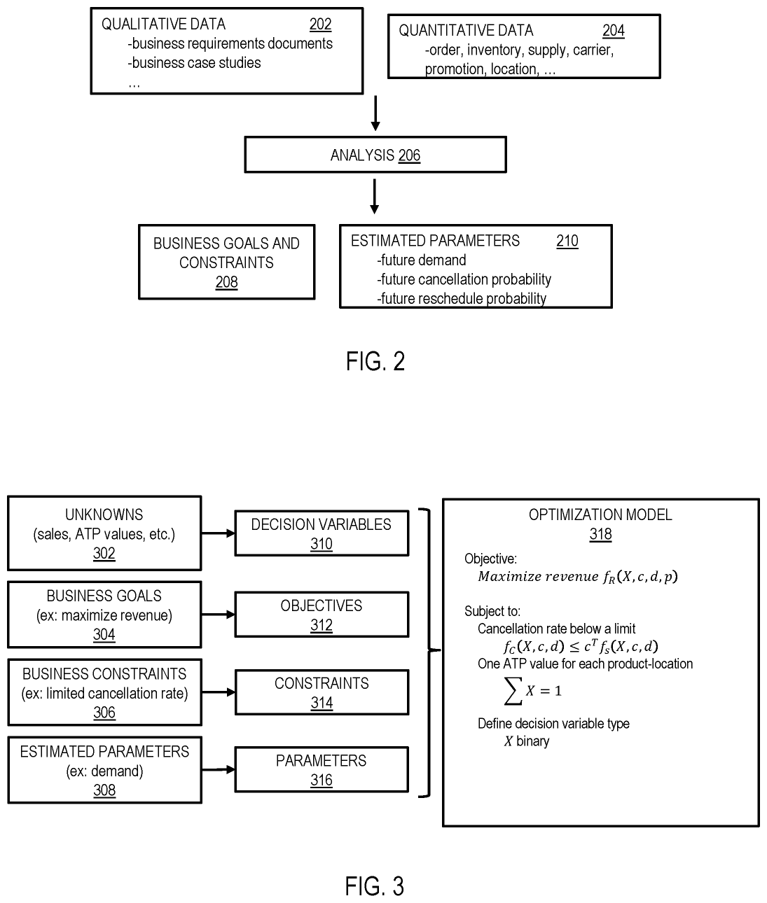

FIG. 2 depicts an example workflow for identifying business goals and constraints, and determining parameters for use in an executable optimization model, in accordance with aspects described herein. Based on input qualitative data 202 and quantitative data 204, content analysis 206 methods, such as narrative analysis or grounded theory analysis, as examples, can be used to investigate the business constraints and goals 208. Qualitative data 202 may be obtained from the retailer based on interviews, requirements documents, and case studies (as examples). The input data can be used to provide an understanding of what the business constraints and goals are generally, and what the priorities of the retailer are or may be. The business goals inform of a direction the retailer wishes to head with the optimization. Retailers may have different business goals, such as maximizing revenue/profit, maximizing customer satisfaction, maximizing inventory exposure, and/or minimizing order cancellation, as examples. Such users may have different objectives that they desire the optimization efforts to hit. In examples, the retailer provides indications of how important the various different markers are to that retailer, providing the retailer's feeling about what it wants to want to emphasize or de-emphasize in the optimization. As part of the goals identification, a point of emphasis may be to understand the retailer-specific tradeoffs between the different goals the retailer is desiring to hit. In particular examples, the tradeoff may be identified in a graphical user interface by way of a slider element that a user manipulates to indicate what/how the retailer desires to optimize-for instance to optimize for profit, to optimize for risk, and so on. Relating this to an objective function, the slider might inform the weights to control different levels of importance of various function terms.

There are also potentially many business constraints. Constraints too might vary from retailer to retailer. The constraints can be identified as parameterized values. As an example, from a logistics standpoint certain carriers might only ship to certain geographic areas. This is a constraint and may be gleaned from the input data. Some retailers might require a floor sample to be on display that cannot be sold as part of online/mobile orders-this is another example of a constraint that could be provided as a parameterized value. In general, quantitative data may be provided from an order history, inventory, carrier availability, location, and/or other information from the retailer.

From this input data (202, 204) can be gleaned what is achievable, and this may be determined using predictive models. Examples include predictive models for future demand, cancellation rates, and reschedule probabilities, for instance. In examples, the analysis 206 uses one or more time series analyses, such as an autoregressive integrated moving average (ARIMA) or a Holt-Winters seasonal method, and regression models/techniques, such as linear regression, random decision forest, or gradient-boosting, to estimate/determine numerical parameters 210. The data can be used to build predictive models for these parameters (e.g., future demand, future order cancellation probability, and future rescheduling probability). By way of specific example, a gradient-boosted tree provides a prediction model for cancellation and a random decision forest method provides a prediction model for demand based on product type. There are just examples of analysis 206.

In a classic optimization model, there are two primary aspects: an objective function indicating what to maximize or minimize, and constraints. In line with embodiments described herein, one of the constraints in the optimization may be the demand equation. What that equation looks like may be defined based on the parameters that are to be used to estimate demand, and then some constraints may be included, for instance constraints limiting the amount to sell to no more than the amount that the retailer has. More generally, in the first aspect described above, a focus may be to identify the data needed to parameterize the goals and constraints on which the optimization model is then built.

In a next aspect, an optimization model is formulated based on the information collected as described above. FIG. 3 depicts an example conceptual formulation of an executable optimization model, in accordance with aspects described herein. A process defines unknowns 302, such as ATP values by channel and other related unknowns, such as sales and cancellation amount, as decision variables 310 of the optimization model. The process uses the business goals 304 to define the objectives 312 of the optimization model, and in this manner the business goals are codified into an objective function to represent what the retailer wants to maximize or minimize. The business constraints 306 are modeled as constraints 314 in the optimization model by translating them into mathematical constraints for satisfaction in the recommended solution. The estimated parameters 308, for instance those for future demand, cancellation, and reschedule probability as examples, are added as parameters 316 on the objectives 312 and constraints 314. By incorporating the business goals 304 and business constraints 306 together, the model finds the best solution within these business restrictions. From these elements (310, 312, 314, 316), a formal optimization model 318 is generated, for instance as a maximum or minimum problem depending on the business goals and formulation of the business problem. The optimization model presents a functional form of the model that can then be solved. In examples, it is solved by a solver executing on a computer system. The solver may be software that executes to model to produce a solution to the optimization problem. It should be appreciated that solving such an executable optimization model is a complex task and not something that can be achieved mentally by a human.

FIG. 3 conceptually depicts the translation of the output from FIG. 2 into an executable (by software) optimization model that encodes the objective and constraints for solving of the model. The solver can solve the optimization model using mathematical decision making techniques. More specifically, example such mathematical decision making techniques include linear programming, nonlinear programming, integer programming, and/or mixed integer programming. Different technique(s) may be used for solving the model depending on the form of the problem. Solving the model produces output, generating values for the unknowns, including an ATP value.

In this manner, the ATP optimization model is solved to generate a recommended ATP value. The model may be formulated and solved across a collection of different products, for different stores, or across any other desired dimension. Additionally, the ATP optimization model may be adaptive to business changes reflected by the input data, and therefore aspects can repeat the identification of constraints/goals, the determination of numerical parameters, the building of an appropriate optimization model, and the executing of such a model, based on updated input data. The receipt of orders may present a different enough situation that the retailer desires to generate and ATP value again, and therefore the model could be run on-demand, periodically, or aperiodically, as new orders are received. Changes to the business or consumer preferences may be automatically incorporated into the latest recommendations. For instance, changed constraints and/or goals might prompt model formulation and execution.

The generated ATP values respect identified business constraints because those constraints can be built into the model. The use of mathematical decision making techniques in building the model ensures that the output both satisfies the business constraints and finds the best possible recommended value(s). As noted, different business have different goals and therefore, depending on those goals and on the constraints of the particular retailer, what is optimal ATP for one retailer may vary from what is optimal for another retailer.

As an enhancement, in some embodiments the general approach can be applied across a variety of domains, such as market segments, product categories, or the like. Formulations might be different for e-commercial platforms than for branch-specific retailers, discount retailing, luxury goods, and so on. The point is that goals and constraints can vary across domains and therefore estimated parameters falling out of those different domains are expected to be different, and change perhaps dramatically depending on the types of products, industry, customer base, and so on. The approach provided herein accounts of these differences, enabling the set-up of optimizations tailored to the particular business needs. The time series analysis and regression modelling could be generalized to adapt to the data quality and product variety changes. And by adding or modifying an optimization objective, for example, this can help different retailers achieve their goals. Additionally, customizability could be provided via slacks and penalties added to model constraints in order to satisfy different tolerances on those business constraints across different retailers.

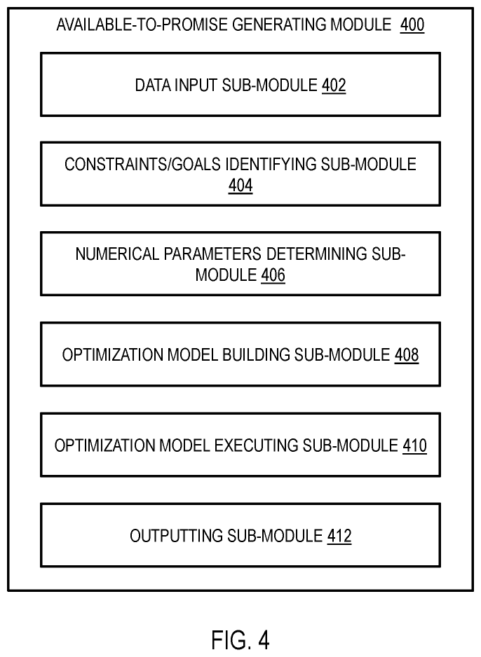

FIG. 4 depicts further details of an example ATP generating module (e.g., ATP generating module 400 of FIG. 1) to incorporate and/or use aspects described herein. In one or more aspects, ATP generating module 400 includes, in one example, various sub-modules to be used to perform ATP value generation for omnichannel retailers. The sub-modules can be or include, e.g., computer readable program code (e.g., instructions) in computer readable media, e.g., persistent storage (e.g., persistent storage 113, such as a disk) and/or a cache (e.g., cache 121), as examples. The computer readable media may be part of a computer program product and may be executed by and/or using one or more computers or devices, and/or processor(s) or processing circuity thereof, such as computer(s) 101, EUD 103, server 104, or computers of cloud 105/106 of FIG. 1, as examples.

Referring to FIG. 4, ATP generating module 400 includes a data input sub-module 402 for obtaining/receiving/intaking input qualitative and quantitative data of an omnichannel retailer, a business constraints and goals identifying sub-module 404 for identifying, for the omnichannel retailer, and based on the input quantitative data and input qualitative data, a collection of business constraints and a collection of business goals, a numerical parameters determining sub-module 406 for determining, using a machine learning model with the collection of business constraints and collection of business goals, numerical parameters for use in an executable optimization model, an optimization model building sub-module 408 for building the executable optimization model using at least one goal of the collection of goals as a respective at least one objective in the optimization model, at least one constraint of the collection of constraints as a respective at least one constraint in the optimization model, and at least one of the determined numerical parameters as at least one additional parameter in the executable optimization model, an optimization model executing sub-module 410 for executing the executable optimization model and generating, based on the executing, an available-to-promise value, and an outputting sub-module 412 for outputting the available-to-promise value, for instance to output the ATP value to an e-commerce system for presentation to potential purchasers.

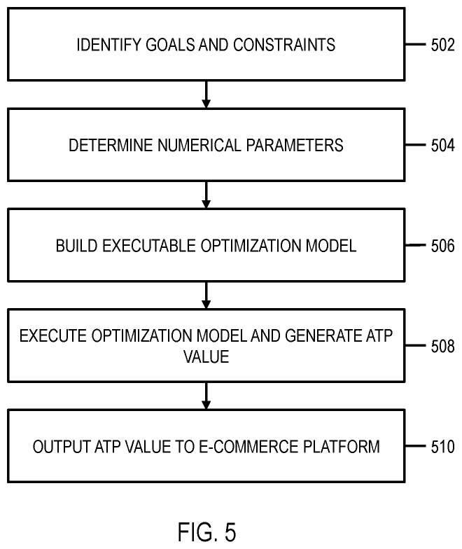

FIG. 5 depicts an example process for available-to-promise value determination, in accordance with aspects described herein. The process may be executed, in one or more examples, by a processor or processing circuitry of one or more computers/computer systems, such as those described herein, and more specifically those described with reference to FIG. 1. The computer system could be part of an e-commerce system/platform or could be in communication with such a system/platform, in examples. In one example, code or instructions implementing the process(es) of FIG. 5 are part of a module, such as module 400. In other examples, the code may be included in one or more modules and/or in one or more sub-modules of the one or more modules. Various options are available.

The process of FIG. 5 begins by identifying (502), for an omnichannel retailer, and based on input quantitative data and input qualitative data, a collection of business constraints and a collection of business goals. In a particular example, the identifying the collection of business constraints and collection of business goals includes identifying (i) one or more business constraint of the collection of business constraints, and (ii) one or more business goal of the collection of business goals, by applying automated content analysis against the quantitative data and/or the qualitative data.

The process of FIG. 5 continues by determining (504), using a machine learning model with the collection of business constraints and collection of business goals, numerical parameters (e.g., estimated parameters) for use in an executable optimization model. In a particular example, the determined numerical parameters include (i) prediction of future demand and inventory, (ii) future order cancellation probability, and/or (iii) future reschedule probability.

In some embodiments, the process also includes building the machine learning model as a predictive model, and using the machine learning model with the collection of business constraints and collection of business goals to determine the numerical parameters includes using the predictive model to predict the estimated parameters as output of the predictive model. Building the predictive model can include, for instance, using regression technique(s), such as linear regression, random decision forest, and/or gradient-boosting. Additionally or alternatively, building the predictive model includes using at least one time series analysis.

Continuing with FIG. 5, the process builds (506) the executable optimization model using (i) at least one goal of the collection of goals as a respective at least one objective in the optimization model, (ii) at least one constraint of the collection of constraints as a respective at least one constraint in the optimization model, and (iii) at least one of the determined numerical parameters as at least one additional parameter in the executable optimization model. The process then executes (508) the executable optimization model and generates, based on the executing, an available-to-promise value. The available-to-promise value includes an indication of how much inventory of the retailer should be made available to promise to prospective online order. In some examples, the executing the executable optimization model is performed by solver software that runs the executable optimization model using one or more mathematical decision making techniques to solve for the available-to-promise value as a decision variable of the executable optimization model. The process also outputs (510) the available-to-promise value to an e-commerce system for presentation to potential purchasers.

The process of FIG. 5 can also repeat one or more aspects, for instance repeat the identifying 502, determining 504, building 506, executing 508, and outputting 510 periodically or aperiodically. For instance, the process may repeat these aspects based on receiving orders and on changed business constraints and/or business goals of the retailer, as an example.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
identifying, for an omnichannel retailer, and based on input quantitative data and input qualitative data, a collection of business constraints and a collection of business goals;
determining, using a machine learning model with the collection of business constraints and collection of business goals, numerical parameters for use in an executable optimization model;
building the executable optimization model using at least one goal of the collection of goals as a respective at least one objective in the optimization model, at least one constraint of the collection of constraints as a respective at least one constraint in the optimization model, and at least one of the determined numerical parameters as at least one additional parameter in the executable optimization model;
executing the executable optimization model and generating, based on the executing, an available-to-promise value, the available-to-promise value comprising an indication of how much inventory of the retailer should be made available to promise to prospective online orders; and
outputting the available-to-promise value to an e-commerce system for presentation to potential purchasers.

2. The method of claim 1, wherein the identifying the collection of business constraints and collection of business goals comprises identifying at least one selected from the group consisting of (i) one or more business constraint of the collection of business constraints, and (ii) one or more business goal of the collection of business goals, by applying automated content analysis against at least one selected from the group consisting of the quantitative data, and the qualitative data.

3. The method of claim 1, further comprising building the machine learning model as a predictive model, wherein the using the machine learning model with the collection of business constraints and collection of business goals to determine the numerical parameters comprises using the predictive model to predict the estimated parameters as output of the predictive model.

4. The method of claim 3, wherein the building the predictive model comprises using at least one selected from the group of regression techniques consisting of: linear regression, random decision forest, and gradient-boosting.

5. The method of claim 4, wherein the building the predictive model further comprises using at least one time series analysis.

6. The method of claim 1, wherein the determined numerical parameters include at least one selected from the group consisting of (i) prediction of future demand and inventory, (ii) future order cancellation probability, and (iii) future reschedule probability.

7. The method of claim 1, wherein the executing the executable optimization model is performed by solver software that runs the executable optimization model using one or more mathematical decision making techniques to solve for the available-to-promise value as a decision variable of the executable optimization model.

8. The method of claim 1, further comprising repeating the identifying, the using a machine learning model, the building an executable optimization model, the executing the executable optimization model, and the outputting, based on receiving orders and on changed at least one selected from the group consisting of: business constraints, and business goals of the retailer.

9. A computer system comprising:
a memory; and
a processor in communication with the memory, wherein the computer system is configured to perform a method comprising:
identifying, for an omnichannel retailer, and based on input quantitative data and input qualitative data, a collection of business constraints and a collection of business goals;
determining, using a machine learning model with the collection of business constraints and collection of business goals, numerical parameters for use in an executable optimization model;
building the executable optimization model using at least one goal of the collection of goals as a respective at least one objective in the optimization model, at least one constraint of the collection of constraints as a respective at least one constraint in the optimization model, and at least one of the determined numerical parameters as at least one additional parameter in the executable optimization model;
executing the executable optimization model and generating, based on the executing, an available-to-promise value, the available-to-promise value comprising an indication of how much inventory of the retailer should be made available to promise to prospective online orders; and
outputting the available-to-promise value to an e-commerce system for presentation to potential purchasers.

10. The computer system of claim 9, wherein the identifying the collection of business constraints and collection of business goals comprises identifying at least one selected from the group consisting of (i) one or more business constraint of the collection of business constraints, and (ii) one or more business goal of the collection of business goals, by applying automated content analysis against at least one selected from the group consisting of the quantitative data, and the qualitative data.

11. The computer system of claim 9, wherein the method further comprises building the machine learning model as a predictive model, wherein the using the machine learning model with the collection of business constraints and collection of business goals to determine the numerical parameters comprises using the predictive model to predict the estimated parameters as output of the predictive model.

12. The computer system of claim 11, wherein the building the predictive model comprises using at least one selected from the group of regression techniques consisting of: linear regression, random decision forest, and gradient-boosting.

13. The computer system of claim 12, wherein the building the predictive model further comprises using at least one time series analysis.

14. The computer system of claim 9, wherein the determined numerical parameters include at least one selected from the group consisting of (i) prediction of future demand and inventory, (ii) future order cancellation probability, and (iii) future reschedule probability.

15. The computer system of claim 9, wherein the executing the executable optimization model is performed by solver software that runs the executable optimization model using one or more mathematical decision making techniques to solve for the available-to-promise value as a decision variable of the executable optimization model.

16. The computer system of claim 9, wherein the method further comprises repeating the identifying, the using a machine learning model, the building an executable optimization model, the executing the executable optimization model, and the outputting, based on receiving orders and on changed at least one selected from the group consisting of: business constraints, and business goals of the retailer.

17. A computer program product comprising:
a computer readable storage medium readable by a processing circuit and storing instructions for execution by the processing circuit for performing a method comprising:
identifying, for an omnichannel retailer, and based on input quantitative data and input qualitative data, a collection of business constraints and a collection of business goals;
determining, using a machine learning model with the collection of business constraints and collection of business goals, numerical parameters for use in an executable optimization model;
building the executable optimization model using at least one goal of the collection of goals as a respective at least one objective in the optimization model, at least one constraint of the collection of constraints as a respective at least one constraint in the optimization model, and at least one of the determined numerical parameters as at least one additional parameter in the executable optimization model;
executing the executable optimization model and generating, based on the executing, an available-to-promise value, the available-to-promise value comprising an indication of how much inventory of the retailer should be made available to promise to prospective online orders; and
outputting the available-to-promise value to an e-commerce system for presentation to potential purchasers.

18. The computer program produce of claim 17, wherein the identifying the collection of business constraints and collection of business goals comprises identifying at least one selected from the group consisting of (i) one or more business constraint of the collection of business constraints, and (ii) one or more business goal of the collection of business goals, by applying automated content analysis against at least one selected from the group consisting of the quantitative data, and the qualitative data.

19. The computer program product of claim 17, wherein the method further comprises building the machine learning model as a predictive model, wherein the using the machine learning model with the collection of business constraints and collection of business goals to determine the numerical parameters comprises using the predictive model to predict the estimated parameters as output of the predictive model.

20. The computer program product of claim 17, wherein the executing the executable optimization model is performed by solver software that runs the executable optimization model using one or more mathematical decision making techniques to solve for the available-to-promise value as a decision variable of the executable optimization model.
